(19) United States
(12) Patent Application Publication
(10) Pub. No.: US 2022/0263451 A1
(43) Pub. Date: Aug. 18, 2022

(54) DRIVE SYSTEM FOR DRIVING A FLUID COMPRESSION DEVICE AND ASSOCIATED POWER SUPPLY METHOD

(71) Applicant: IFP Energies nouvelles, RUEIL-MALMAISON (FR)

(72) Inventors: Alexandre BATTISTON, RUEIL-MALMAISON (FR); Laid KEFSI, RUEIL-MALMAISON (FR); Siyamak SARABI, RUEIL-MALMAISON (FR)

(21) Appl. No.: 17/765,467

(22) PCT Filed: Sep. 24, 2020
(86) PCT No.: PCT/EP2020/076691

§ 371 Date: Mar. 31, 2022

(30) Foreign Application Priority Data
Oct. 7, 2019 (FR) FR1911066

(51) Int. Cl. H02P 27/08; F04D 25/06; F04D 17/10; F02B 39/10

(52) U.S. Cl. CPC H02P 27/08; F02B 39/10; F04D 17/10; F04D 25/06

(57) ABSTRACT

The invention relates to a drive system comprising an inverter a first input, a second input and N outputs, a rotary machine comprising a stator and a rotor comprising at least one magnetic element made from a modular magnetization material, an output switching device connected between a common point and the second input, and a control device which simultaneously during magnetization of the at least one magnetic element step controls the output switching device to be on for a predetermined magnetization time interval, and controls the inverter to connect during the magnetization time interval, the first input to at least one and at most N-1 outputs.

### CROSS-REFERENCE TO RELATED APPLICATIONS

Reference is made to PCT/EP2020/076691 filed Sep. 24, 2020, designating the United States, and French Application No. 19/11.066 filed Oct. 7, 2019, which are incorporated herein by reference in their entirety.

### BACKGROUND OF THE INVENTION

### Field of the Invention

The present invention relates to a drive system comprising an inverter, a rotary electric machine and a control device, to a power supply method implemented by a drive system, to a compression assembly comprising such a system and to rotatory electric machines, in particular to turbomachines and specifically to a compressor or a turbocharger on board a vehicle,

The inverter comprises a first input, a second input and N outputs, each one of the first input and the second input to be connected to a different terminal of a direct current source, each output being associated with a respective electric phase, N being a natural number greater than or equal to 2, the rotary machine comprising a stator and a rotor which rotates relative to the stator about a rotation axis, the stator comprising N windings, each winding having an input and an output, the input of each winding being connected to a corresponding output of the inverter and the outputs of the stator windings being connected at a common point.

### Description of the Prior Art

A conventional method of manufacturing a rotary machine comprises fastening already magnetized permanent magnets onto a rotor body with the rotor being then arranged in a cavity of a corresponding stator.

Such a method however involves many drawbacks. In particular, when assembling the rotor with the stator, the rotor (which comprises the already magnetized permanent magnets) generates magnetic forces likely to cause assembly problems with the stator, and an increased risk of rotor/stator shocks leading to damage.

In order to overcome such inconvenience, it has been proposed to produce a rotary electric machine by arranging in a stator cavity a rotor comprising elements (referred to as magnetic elements) made from a non-magnetized magnetic material. In the absence of magnetization, the electric machine assembly process is simplified. Once this assembly achieved, a magnetic field is generated in the cavity by dedicated windings mounted in the stator, so as to magnetize the magnetic elements of the rotor.

However, such a manufacturing method is not entirely satisfactory.

Indeed, such a manufacturing method requires a dedicated structure for magnetizing the magnetic elements of the rotor, which has a negative impact on the size and the manufacturing cost of the rotary machine.

Moreover, the rotary machine obtained with such a manufacturing method is not optimal within the context of driving a turbomachine, in particular a turbocharger for a vehicle. Indeed, in such an on-board application, the rotary machine is only used on an ad hoc basis. In this case, when it is not powered, the rotary machine generates a rotation resisting torque, which leads to no-load losses. It is therefore necessary to be able to modulate the value of the magnetic element flux, and notably to reduce, or even to cancel, the flux in the phases during which the machine is not powered.

### SUMMARY OF THE INVENTION

The invention thus provides a drive system that is simpler and more cost-effective, while generating smaller losses when the rotary machine it comprises is not operated.

The invention is thus a drive system of the aforementioned type additionally comprising an output switching device connected between the common point and the second input of the inverter;

the rotor comprising at least one magnetic element made from a modular magnetization material;

the control device being configured to simultaneously, during a step of magnetization of each magnetic element of the rotor to:

control the output switching device to set it an on-state setting for a predetermined magnetization time interval; and control the inverter to connect, during the magnetization time interval, the first input of the inverter being at least to one and at most N-1 output(s) of the inverter, forming each a magnetization output, and to disconnect the second input of the inverter from each magnetization output.

In such a drive system, during the magnetization step, the inverter is controlled so that the magnetic field intended to magnetize the magnetic elements is generated by the stator windings that are commonly used to set the rotor in motion. Magnetization of the magnetic elements is thus made possible without any additional dedicated structure, which provides an advantage in terms of weight and manufacturing cost in relation to systems of the prior art.

Furthermore, such a drive system makes possible modification of at least one of the amplitude and the direction of magnetization of the magnetic elements of the rotor according to operating conditions. More precisely, in the drive system according to the invention, the direction and the amplitude of the magnetic field generated by the stator depend on the selected inverter magnetization outputs. Now, the stator magnetic field influences the magnetization of the magnetic elements of the rotor.

In particular, when operation of the rotary electric machine is no longer required to drive the fluid compression device. The drive system according to the invention advantageously allows, by judicious choice of the magnetization outputs to apply to the magnetic elements a magnetic field having the effect of modifying and notably to substantially reduce or even cancelling the magnetization of the magnetic elements. Such magnetic elements are thus referred to as “modular magnetization” elements.

It follows that the rotary machine, which is mechanically coupled to the fluid compression device and is driven thereby even when it is not electrically operated, generates a braking force that is much lower than with a drive system of the prior art which is devoid of an inverter configured to modify the magnetization of the magnetic elements according to operating conditions.

Modular magnetization is relevant for an electrified turbocharger whose operation and power demands in motor and generator mode are transient (pulsed operation mode). The rotor made magnetically inert when operation of the electric rotary machine is no longer required which limits the losses of the drive system when it is not used, in relation to a drive system of the prior art.

According to other advantageous aspects of the invention, the drive system comprises one or more of the following characteristics, taken in isolation or with all the technically possible combinations:

the drive system further comprises a load connected in series between the output switching device and the second input of the inverter;

the duration of the magnetization time interval depends on the modular magnetization material and/or on the number of magnetization outputs; and

the duration of the magnetization time interval further depends on the impedance of the load.

The control device is in addition configured, during the magnetization step, to:

detect a magnetic field generated by the rotor;

select each magnetization output according to the detected magnetic field; the control device is further configured to carry out the magnetization step prior to a rotary machine excitation step.

The control device is configured to simultaneously, during the excitation step:

control the output switching device so as to set it to off-state; and

control the inverter according to a predetermined inverter control law to connect, successively in time, each inverter output to at least one of the first input and the second input of the inverter.

Furthermore, the invention is a power supply method for a rotary electric machine using an inverter comprising a first input, a second input and N outputs with each output being associated with a respective electric phase, with N being a natural number greater than or equal to 2;

the rotary machine comprising a stator and a rotor arranged in a cavity of the stator and is mobile in rotation relative to the stator about a rotation axis;

the stator comprising N windings, each winding having an input and an output, the input of each winding being connected to a corresponding output of the inverter, the outputs of the windings being connected at a common point;

the rotor comprising at least one magnetic element made from a modular magnetization material; and

an output switching device connected between the common point and the second input of the inverter.

The supply method comprises magnetizing each magnetic element of the rotor including:

connecting each first input and second input to a respective terminal of a direct current source;

controlling the output switching device to be on for a predetermined magnetization time interval; and

controlling the inverter to connect, during the magnetization time interval, the first input of the inverter to at least one and at most N-1 output(s) of the inverter, forming a magnetization output, and disconnecting the second input of the inverter from each magnetization output, to simultaneously inject, into each winding connected to a respective magnetization output, an electric current to generate, in the stator cavity, a magnetic field intended to magnetize each magnetic element.

According to another advantageous aspect of the invention, the supply method comprises the following characteristics, in isolation or in combination.

The supply method further comprises, during the magnetization step:
detecting a magnetic field generated by the rotor; and
selecting each magnetization output according to the detected magnetic field.

The supply method further comprises a rotary machine excitation step subsequent to the magnetization step, simultaneously comprising:
controlling the output switching device to be off; and
controlling the inverter according to a predetermined inverter control law to connect, successively in time, each inverter output to at least one of the first input and the second input of the inverter, to inject an electric current into the stator windings to generate, in the stator cavity, a rotary magnetic field to drive the rotor in rotation about the rotation axis.

Furthermore, the object of the invention is a compression assembly comprising a fluid compression device and a drive system as defined above, the fluid compression device being coupled to the stator of the rotary machine of the drive system for drive thereof.

According to an advantageous aspect of the invention, the compression assembly comprises the characteristic as follows: the fluid compression device is a turbocharger combining a turbine and a compressor, notably for an internal-combustion engine, or a microturbine.

### BRIEF DESCRIPTION OF THE DRAWINGS

Other features and advantages of the invention will be clear from reading the description hereafter, given by way of non-limitative example, with reference to the accompanying figures wherein:

FIG. 1 schematically shows an assembly comprising a drive system according to the invention, associated with a direct current source;

FIG. 2 schematically shows in sectional view a rotary machine of the drive system of FIG. 1, in a transverse plane of the rotary machine according to an embodiment of the invention;

FIG. 3 schematically illustrates the electrical circuit of the assembly of FIG. 1, during a magnetization step wherein an electric current is injected into a single winding of a stator of the rotary machine of FIG. 2;

FIG. 4 schematically shows in sectional view the stator of the rotary machine of FIG. 2, in a transverse plane of the rotary machine, during the magnetization step of FIG. 3;

FIG. 5 is similar to FIG. 3, an electric current being injected into two windings of the stator; and

FIG. 6 is similar to FIG. 4, with the stator being illustrated during the magnetization step of FIG. 5.

### DETAILED DESCRIPTION OF THE INVENTION

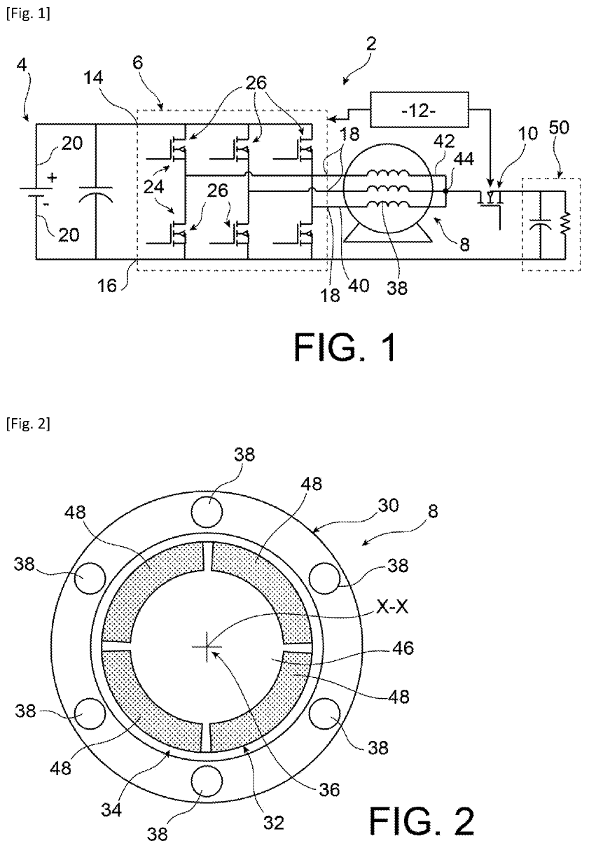

A drive system 2 according to the invention is illustrated by way of non-limitative example in FIG. 1. In this figure, a direct current source 4 is connected to the input of drive system 2.

Drive system 2 comprises an inverter 6, a rotary electric machine 8, an output switching device 10 and a control device 12.

Inverter 6 delivers an electric current from source 4 to windings (described hereafter) of rotary machine 8, in a selective manner.

Rotary machine 8 drives in rotation an element connected to its output shaft, in particular a fluid compression device, a compressor or a turbocharger for example.

Moreover, control device 12 is configured to control inverter 6 and output switching device 10.

Inverter 6 comprises a first input 14, a second input 16, and N outputs 18. N is a natural number greater than or equal to 2, equal to 3 for example, as illustrated in FIG. 1.

Inputs 14, 16 of inverter 6 are the inlets of drive system 2. Each one of the first and second inputs 14, 16 is intended to be connected to a respective terminal 20 of source 4. In addition, each output 18 is associated with a respective electric phase, and it is connected to a corresponding winding of rotary machine 8.

According to a structure example, inverter 6 comprises N arms 26, each arm 26 being connected between first input 14 and second input 16 of inverter 6.

Each arm 26 is associated with an output 18 of inverter 6, and it comprises two half-arms 24 in series, connected together at a connection point forming output 18 corresponding to the arm 26.

Each half-arm 24 comprises a switching module for switching between an off-state preventing electric current flow and an on-state allowing electric current flow.

For example, switching modules 26 of inverter 6 are insulated-gate bipolar transistors IGBT or metal oxide semiconductor field effect transistors MOSFET.

As illustrated in FIG. 2 by way of non-limitative example, rotary machine 8 comprises a stator 30 and a rotor 32 mobile which rotates relative to stator 30, about a rotation axis X-X.

More precisely, stator 30 comprises a cavity 34 in which rotor 32 is positioned.

Output shaft 36 of rotary machine 8, mentioned above, extends along rotation axis X-X and is integral with rotor 32 to be driven in rotation about rotation axis X-X.

Stator 30 comprises N windings 38, arranged in a known manner, for generating a magnetic field in cavity 34 when traversed by an electric current. For example, windings 38 are arranged in such a way that the magnetic fields corresponding to two distinct windings 38 are mirror images of one another through a rotation by a non-zero angle multiple of 360°/N.

The magnetic field generated by windings 38 notably forms an excitation magnetic field to drive rotor 32 in rotation about rotation axis X-X.

As described hereafter, the magnetic field generated by windings 38 forms a magnetization magnetic field to magnetize at least one magnetic element 48 (inserts for example) of rotor 32 prior to the rotation thereof.

Each winding 38 comprises an input 40 and an output 42.

Input 40 of each winding 38 is connected to a corresponding output 18 of inverter 6. Moreover, outputs 42 of windings 38 are connected at a common point 44, which is referred to as neutral point of rotary machine 8.

Rotor 32 comprises at least one magnetic element 48 made from a modular magnetization material.

A modular magnetization material is understood to be, in the sense of the present invention, a ferromagnetic material, preferably a soft ferromagnetic material or a semi-hard ferromagnetic material.

A soft ferromagnetic material is a ferromagnetic material having a coercive field below 1000 A·m−1 (Ampere per meter).

Furthermore, a semi-hard ferromagnetic material is a ferromagnetic material having a coercive field ranging between 1000 A·m−1 and 100,000 A·m−1, for example between 1000 A·m−1 and 10,000 A·m−1.

Such a material is, for example, an alloy known as FeCrCo, containing iron, chromium and cobalt, or an alloy known as AlNiCo, containing aluminium, nickel and cobalt.

For example, each magnetic element 48 is an insert integral with a body 46 of rotor 32. For example, each insert 48 is integrated in body 46 or positioned on the periphery of body 46.

In this case, rotor 32 advantageously comprises inserts 48 circumferentially positioned around rotation axis X-X, preferably at regular angular intervals.

Preferably, each insert 48 extends along rotation axis X-X.

According to a variant (not shown), the magnetic element forms all or part of the body of rotor 32. According to one aspect, the magnetic element can have the shape of a ring.

In the rest of the description, only the first variant (modular insert magnetization) is described, but the invention is identical for a rotor consisting at least partly of such a magnetic element.

Output switching device 10 is connected between common point 44 and second input 16 of inverter 6.

Output switching device 10 is designed to switch between an off-state preventing electric current flow and an on-state allowing electric current flow.

For example, output switching device 10 is a MOSFET transistor or a relay.

As described above, control device 12 is configured to control inverter 6 and output switching device 10. In particular, control device 12 is configured to control inverter 6 in order to selectively connect outputs 18 of inverter 6 to at least one of first input 14 and second input 16 of inverter 6. Furthermore, control device 12 is configured to control the on-state or the off-state of output switching device 10.

More precisely, control device 12 is configured to control inverter 6 and output switching device 10, during a step of magnetizing each magnetic element 48 of rotor 32, to cause a direct electric current to flow through at least one and at most N-1 winding(s) 38 of stator 30. In case an electric current is injected into two or more windings 38, such an injection is simultaneous.

In particular, control device 12 is configured to simultaneously, during the magnetization step:

control output switching device 10 to set it to an on-state for a predetermined magnetization time interval; and

control inverter 6 to connect, during the magnetization time interval, first input 14 of inverter 6 to at least one and at most N-1 output(s) 18 of inverter 6, each forming a magnetization output, and to disconnect second input 16 of inverter 6 from each magnetization output.

Such a control of inverter 6 and of output switching device 10 prevents an electric current from flowing through inverter 6 between second input 16 of inverter 6 and each magnetization output. In this case, the electric current is caused to flow from first input 14 to second input 16 of the inverter through windings 38 and output switching device 10. This results in a current pulse flowing through the windings connected to magnetization output(s) 18, and in the generation of a magnetic field in cavity 34 intended to magnetize each magnetic element 48.

Preferably, the duration of the magnetization time interval is selected according to the material from which each magnetic element 48 is made. Indeed, the magnetization time interval corresponds to the time interval during which each magnetic element 48 is exposed, during the magnetization step, to the magnetic field intended to provide its magnetization. For a given amplitude of such a magnetic field, the duration of the magnetization time interval is selected so as to ensure magnetization of each magnetic element 48.

Preferably, the duration of the magnetization time interval is also selected according to the number of magnetization outputs. Indeed, the amplitude of the current flowing through each winding 38 during the magnetization step decreases with the number of windings 38 supplied with current. For a given number of windings 38 supplied with current, the duration of the magnetization time interval is selected to ensure magnetization of each magnetic element 48.

Windings 38 are arranged to generate magnetic fields in different directions. The amplitude of the total magnetic field in cavity 34 also decreases with the number of windings 38 supplied with current, which results in an increase in the minimum duration allowing magnetization of each magnetic element 48, which is the minimum duration of the magnetization time interval.

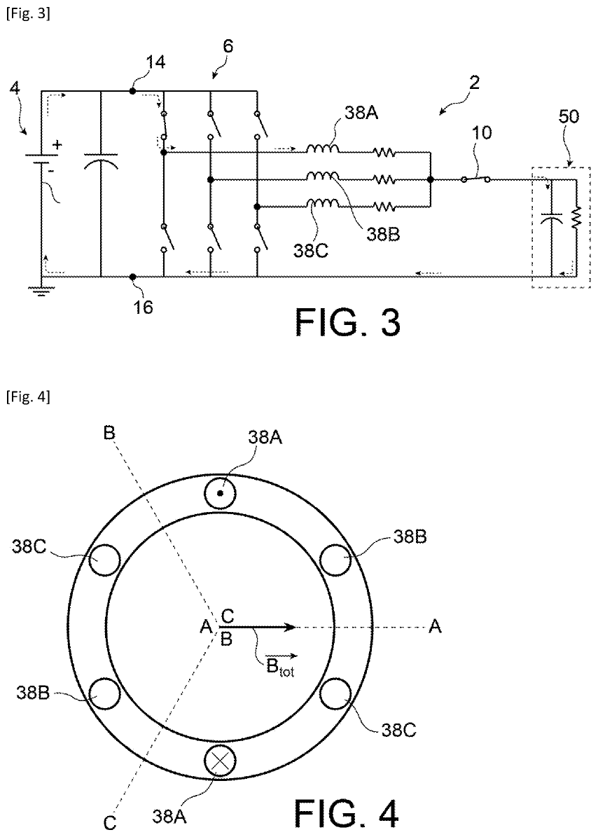

In the example illustrated in FIG. 3, rotary machine 8 is a three-phase machine, and inverter 6 is controlled in such a way that, during the magnetization step, a single winding denoted by 38A is traversed by the electric current delivered by source 4, whose path is illustrated by arrows. The other two windings, 38B and 38C respectively, are disconnected from first input 14 of inverter 6 and they are not supplied with current. In this case, the current flowing through winding 38A has an intensity im.

In this example, and as illustrated in FIG. 4, winding 38A generates, along an axis A-A associated with winding 38A, a total magnetic field \vec{Bₜₒₜ} of amplitude Bm depending on intensity im of the current. Moreover, no magnetic field is generated in directions B-B and C-C associated with windings 38B and 38C respectively. As a result, for a sufficient amplitude Bm of the magnetic field and a sufficient duration of the magnetization time interval, a magnetization appears within each magnetic element 48 and persists at the end of the magnetization time interval.

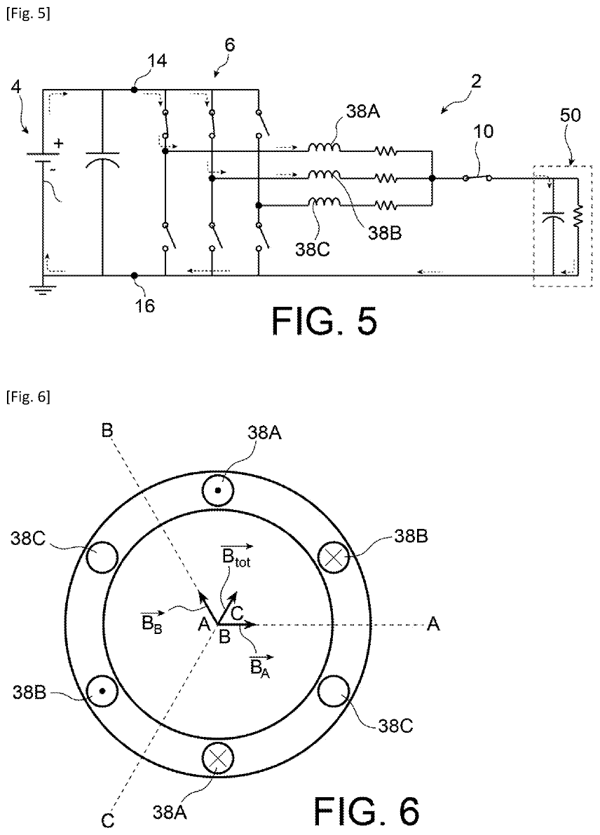

In the example illustrated by FIG. 5, rotary machine 8 is a three-phase machine, and inverter 6 is controlled in such a way that, during the magnetization step, windings 38A and 38B are traversed by the electric current delivered by source 4, whose path is illustrated by arrows. Winding 38C is disconnected from first input 14 of inverter 6 and it is not supplied with current. In this case, the current flowing through each winding 38A, 38B has an intensity im/2.

In this example, and as illustrated by FIG. 6, winding 38A generates, along axis A-A, a magnetic field of amplitude Bm/2.Moreover, winding 38B generates, along axis B-B, a magnetic field of amplitude Bm/2. The magnetic fields generated by windings 38A, 38B have an angle of 120° between them. The total magnetic field \vec{Bₜₒₜ} has an amplitude Bm/2. As a result, for a sufficient duration of the magnetization time interval, a magnetization appears within each magnetic element 48 and persists at the end of the magnetization time interval.

The amplitude of the total magnetic field of the first example of FIGS. 3, 4 being greater than that of the total magnetic field of the second example of FIGS. 5, 6, the minimum duration of the magnetization time interval of the first example is less than or equal to the minimum duration of the magnetization time interval of the second example.

It may be noted that, in FIGS. 4, 6, stator 30 comprises a single pole per winding 38. However, a larger number of poles per winding 38 is possible.

Furthermore, control device 12 is advantageously configured to carry out the magnetization step prior to a step of exciting rotary machine 8. Such an excitation step comprises controlling inverter 6 so as to inject into windings 38 of stator 30 an electric current in order to generate, in cavity 34, a magnetic excitation field intended to cause rotation of rotor 32 about rotation axis X-X.

More precisely, control device 12 is configured to simultaneously, during the excitation step:

control output switching device 10 to set it to an off-state; and

control inverter 6 according to a predetermined inverter control law (pulse width modulation control for example) to connect, successively in time, first input 14 and second input 16 of inverter 6 to each output 18 of inverter 6.

The purpose of such an excitation step is to cause rotation of rotor 32 about its axis X-X. This is made possible by the presence of a magnetization within magnetic elements 48 of rotor 32, as a result of the magnetization step described above.

Optionally, drive system 2 further comprises a load 50 connected in series between output switching device 10 and second input 16 of inverter 6. Such a load comprises, for example, a capacitor and a resistor mounted in parallel.

In this case, the intensity of the current flowing through inverter 6 and windings 38 during the magnetization step also depends on the impedance of load 50.

Addition of such a load 50 is advantageous insofar as the current intensity during the magnetization step is reduced in relation to the intensity of the current that would flow in the absence of a load. The components of inverter 6 and of stator 30 are less likely to be damaged by overintensities.

The operation of drive system 2 is now described.

During a step of assembling rotary machine 8, magnetic elements 48 of rotor 32 are not magnetized, and rotor 32 is arranged in cavity 34 of stator 30.

Moreover, during assembling drive system 2, input 40 of each winding 38 of stator 30 is connected to a corresponding output 18 of inverter 6. Common point 44 is connected to second input 16 output switching device 10.

Each first input 14 and second input 16 of inverter 6 is then connected to a respective terminal of direct current source 4.

Then, during the step of magnetizing each magnetic element 48 of rotor 32, control device 12 controls output switching device 10 in such a way that it is in on-state during the predetermined magnetization time interval. Furthermore, control device 12 controls inverter 6 to connect, during the magnetization time interval, first input 14 of the inverter to the or to each magnetization output, and to disconnect second input 16 of inverter 6 from each magnetization output. Any flow of electric current, directly through inverter 6, between second input 16 of the inverter and each magnetization output, is thus prevented. As a result, an electric current is simultaneously injected into each winding 38 connected to a respective magnetization output, in order to generate, in cavity 34 of stator 30, a magnetic field intended to magnetize each magnetic element 48.

Then, during the step of exciting rotary machine 8 subsequent to the magnetization step, control device 12 simultaneously controls:

output switching device 10 to set it to an off-state, and

inverter 6 according to a predetermined inverter control law to connect, successively in time, first input 14 and second input 16 of inverter 6 to each output 18 of the inverter in order to inject excitation currents into each winding 38 of stator 30 to generate, in cavity 34 of stator 30, a rotary magnetic field intended to drive rotor 32 in rotation about rotation axis X-X.

In a variant, control device 12 also comprises a means for detecting a magnetic field generated by rotor 32 with the origin of the magnetic field being the magnetization of magnetic elements 48. In this case, control device 12 is also configured to carry out, notably after the step of exciting rotary machine 8, an additional magnetization step that differs from the magnetization step described above only in that control device 12 further performs:

detection of the magnetic field generated by rotor 32; and

selection of each magnetization output according to the magnetic field that is detected.

Such a feature is advantageous insofar as judicious choice of the magnetization outputs leads to the generation, by the stator, a magnetic field for modulating, in particular to reduce or even to cancel the magnetization of magnetic elements 48. This has the effect of reducing the losses due to rotary machine 8 when operation of the rotary machine 8 is no longer required, in relation to a situation where such a modulation of the magnetic elements magnetization would not be carried out.

1-11. (canceled)

12. A drive system comprising:
an inverter, a rotary electric machine and a control device, the inverter including a first input, a second input and N outputs, the first input and the second inputs being configured to be connected to respective terminals of a direct current source, each output being associated with a different electric phase, N being a natural number greater than or equal to 2, and the rotary machine comprising a stator and a rotor which rotates relative to the stator about a rotation axis, the stator comprising N windings, each stator winding having an input and an output, each input stator winding being connected to a corresponding output of the inverter, and the outputs of the stator windings being connected at a common point, an output switching device connected between the common point and the second input of the inverter and the rotor comprising at least one magnetic element made from a modular magnetization material; and
the control device during magnetization of each magnetic element of the rotor, simultaneously controlling the output switching device to be on for a predetermined magnetization time interval and controlling the inverter during magnetization time intervals of each magnetic element of the rotor to connect the first input of the inverter to at least one and at most N-1 outputs of the inverter to select magnetization outputs and to disconnect the second input of the inverter from each selected magnetization output.

13. A drive system as claimed in claim 12, comprising a load connected in series between the output switching device and the second input of inverter.

14. A drive system as claimed in claim 12, wherein the magnetization time interval depends on at least one of the modular magnetization material and on a number of magnetization outputs.

15. A drive system as claimed in claim 13, wherein the duration of the magnetization time interval depends on at least one of the modular magnetization material and a number of magnetization outputs.

16. A drive system as claimed in claim 15, wherein the duration of the magnetization time interval depends on impedance of a load of the electric machine.

17. A drive system as claimed in claim 12, wherein the control device detects, during the magnetization of the modular magnetization material, a magnetic field generated by the rotor and selects each magnetization output according to the detected magnetic field generated by the rotor.

18. A drive system as claimed in claim 13, wherein the control device detects, during the magnetization of the modular magnetization material, a magnetic field generated by the rotor and selects each magnetization output according to the detected magnetic field generated by the rotor.

19. A drive system as claimed in claim 14, wherein the control device detects, during the magnetization of the modular magnetization material, a magnetic field generated by the rotor and selects each magnetization output according to the detected magnetic field generated by the rotor.

20. A drive system as claimed in claim 15, wherein the control device detects, during the magnetization of the modular magnetization material, a magnetic field generated by the rotor and selects each magnetization output according to the detected magnetic field generated by the rotor.

21. A drive system as claimed in claim 12, wherein the control device controls magnetization of the modular magnetization material prior to excitation of a rotary electric machine and simultaneously during the excitation of the rotory machine controls the output switching device to be off; and
the inverter connector is controlled according to a predetermined inverter control law to successively connect each output of the inverter to at least one of the first input and the second input of the inverter.

22. A drive system as claimed in claim 13 wherein the control device controls magnetization of the modular magnetization material prior to excitation of a rotary electric machine and simultaneously during the excitation of the rotory machine controls the output switching device to be off; and
the inverter connector is controlled according to a predetermined inverter control law to successively connect each output of the inverter to at least one of the first input and the second input of the inverter.

23. A drive system as claimed in claim 14, wherein the control device controls magnetization of the modular magnetization material prior to excitation of a rotary electric machine and simultaneously during the excitation of the rotory machine controls the output switching device to be off; and
the inverter connector is controlled according to a predetermined inverter control law to successively connect each output of the inverter to at least one of the first input and the second input of the inverter.

24. A drive system as claimed in claim 16, wherein the control device controls magnetization of the modular magnetization material prior to excitation of a rotary electric machine and simultaneously during the excitation step of the rotory machine controls the output switching device to be off; and
the inverter connector is controlled according to a predetermined inverter control law to successively connect each output of the inverter to at least one of the first input and the second input of the inverter.

25. A power supply method of a rotary electric machine having an inverter including a first input, a second input and N outputs, each output being associated with a different electric phase, N being a natural number greater than or equal to 2, the rotary electric machine comprising a stator and a rotor positioned in a cavity of the stator and which rotates relative to the stator about a rotation axis, the stator comprising N windings, each of the N stator windings having an input and an output, the input of each stator winding being connected to a corresponding output of the inverter, the outputs of the stator windings being connected at a common point, the rotor comprising at least one magnetic element made from a modular magnetization material, and an output switching device connected between the common point and the second input of inverter, the power supply method comprising:
magnetizing each magnetic element of the rotor by connecting each first input and each second input to a different terminal of a direct current source;
controlling the output switching device to be on for a predetermined magnetization time interval; and
controlling the inverter to connect the first input of the inverter to at least one and at most N-1 outputs of the inverter during the magnetization time interval, selecting magnetization outputs, and disconnecting the second input of the inverter from each selected magnetization output to simultaneously inject into each stator winding connected to a respective magnetization output an electric current to generate in the cavity of stator a magnetic field which magnetizes each magnetic element of the rotor.

26. A power supply method as claimed in claim 25, comprising during the magnetization step:
detecting a magnetic field generated by rotor; and
selecting each magnetization output according to the detected magnetic field.

27. A power supply method as claimed in claim 25, comprising:
performing excitation of a rotary machine subsequent to the magnetization step and simultaneously;
controlling the output switching device to be off; and
controlling the inverter according to a predetermined inverter control law to connect, successively in time, each output of inverter to at least one of the first input and the second input to inject an electric current into windings of the stator to generate, in the cavity of the stator, a rotary magnetic field which rotates the rotor about rotation axis of the rotor.

28. A compression assembly comprising a fluid compression device and a drive system as claimed in claim 12, wherein the fluid compression device is coupled to the stator of a rotary machine of a drive system which drives the fluid compression device.

29. A compression assembly comprising a fluid compression device and a drive system as claimed in claim 13, wherein the fluid compression device is coupled to the stator of a rotary machine of a drive system which drives the fluid compression device.

30. A compression assembly comprising a fluid compression device and a drive system as claimed in claim 15, wherein the fluid compression device is coupled to the stator of a rotary machine of a drive system which drives the fluid compression device.

31. A power supply method as claimed in claim 27, wherein the fluid compression device is a turbocharger comprising a turbine and a compressor is used for in internal-combustion engine or in a microturbine.
